(19) United States
(12) Patent Application Publication
(10) Pub. No.: US 2018/0050344 A1
(43) Pub. Date: Feb. 22, 2018

(54) PAPER SHREDDER AC/DC MOTOR CONTROLLER

(71) Applicant: AURORA OFFICE EQUIPMENT CO., LTD. SHANGHAI, Shanghai (CN)

(72) Inventors: Bin Zhang, Shanghai (CN); Tao Kuei Chuang, Shanghai (CN); Yung Kang Tso, Shanghai (CN); Chung Shih Tsai, Hawthorne, CA (US)

(73) Assignee: AURORA OFFICE EQUIPMENT CO., LTD. SHANGHAI, Shanghai (CN)

(21) Appl. No.: 15/238,601

(22) Filed: Aug. 16, 2016

(51) Int. Cl. B02C 18/00; B02C 18/16; B02C 25/00

(52) U.S. Cl. CPC B02C 18/0007; B02C 2018/164; B02C 25/00; B02C 18/16

(57) ABSTRACT

A paper shredder controller, with an all-analog controller including a power supply circuit, coupled to a door open switch circuit, an automatic forward control circuit, an automatic reverse control circuit, and a wastebin full circuit. The paper shredder controller includes an overload circuit, a forward-reverse control and relays circuit, a forward-reverse model delay setting circuit, and an overheating protection circuit. Further includes a POWER indicator light; a DOOR OPEN light; an AUTOMATIC FORWARD light; an OVERHEATING light, and a WASTEBIN FULL light.

### BACKGROUND

### 1. Field of the Invention

The present invention relates to paper shredders and, in particular, to paper shredder controllers.

### 2. Background Art

Present paper shredder controllers contain at least one programmable digital integrated circuits (chips), which require programming, timing analysis, and functional testing. The presence of the chips impose a cost in man-hours, which can add to the cost of the device. What is desired is a paper shredder controller without a programmable digital IC processor.

### SUMMARY

Embodiments herein provide a paper shredder controller, including a power supply circuit, coupled to a door open switch circuit, to an automatic forward control circuit, to an automatic reverse control circuit, and to a wastebin full circuit, in which the controller is an all-analog controller and lacks a programmable digital integrated circuit. In some embodiments, the paper shredder controller includes an overload circuit coupled to the power supply circuit. In yet other embodiments, the controller includes a forward-reverse control and relays circuit, coupled to the power supply circuit. Still in other embodiments, the controller includes a forward-reverse model delay setting circuit, coupled to the power supply circuit. In yet other embodiments, the controller includes an overheating protection circuit, coupled to the power supply circuit. Embodiments further include a POWER indicator light, coupled to the power supply circuit, and indicative of the power supply circuit being energized; a DOOR OPEN light coupled to the door open switch circuit, and indicative of a wastebin door being open; an AUTOMATIC FORWARD light, coupled to the automatic forward control circuit, and indicative of the shredder operating in an automatic forward mode; and a WASTEBIN FULL light, coupled to the wastebin full circuit, and indicative of a wastebin being full. In still another embodiment is included an OVERHEATING light, coupled to the overheating circuit, and indicative of an overheating condition.

Still other embodiments include a paper shredder, having an all-analog controller that lacks a programmable digital integrated circuit coupled to a power supply circuit, the power supply circuit coupled to and the all-analog controller controlling: a door open switch circuit; an automatic forward control circuit; an automatic reverse control circuit; a wastebin full circuit; an overload circuit; a forward-reverse control and relays circuit; a forward-reverse model delay setting circuit; and a motor overheating protection circuit.

Embodiments further include a POWER indicator light, coupled to the power supply circuit, and indicative of the power supply circuit being energized; a DOOR OPEN light coupled to the door open switch circuit, and indicative of a wastebin door being open; an AUTOMATIC FORWARD light, coupled to the automatic forward control circuit, and indicative of the shredder operating in an automatic forward mode; a WASTEBIN FULL light, coupled to the wastebin full circuit, and indicative of a wastebin being full; and a MOTOR OVERHEATING light, coupled to the motor overheating circuit, and indicative of a motor overheating condition. In yet additional embodiments, a paper shredder includes an all-analog controller that lacks a programmable digital integrated circuit. Other embodiments include a paper shredder with a housing, a motor within the housing, counter-rotating shredder blades coupled to the motor and covered by the housing, a wastebin coupled to the housing and disposed beneath the shredder blades, and an all-analog shredder controller board, coupled to the housing, and configured to operate the paper shredder in an automatic forward direction and an automatic reverse direction.

### BRIEF DESCRIPTIONS OF THE DRAWINGS

Embodiments of the present invention disclosed herein are illustrated by way of example, and are not limited by the accompanying figures, in which like references indicate similar elements, and in which:

FIG. 1 depicts an example of a paper shredder, in accordance with the teachings of the present invention;

FIG. 2 is a cut-away side view of the paper shredder of FIG. 1, in accordance with the teachings of the present invention;

FIG. 3 illustrates a floor plan pertaining to the main controller circuit schematic of FIG. 4, in accordance with the teachings of the present invention; and

FIG. 4 illustrates the main controller circuit schematic, in accordance with the teachings of the present invention.

### DETAILED DESCRIPTION OF EMBODIMENTS

The present invention can reduce the cost of a paper shredder controller using an all-analog controller design, which eliminates the need for a programmable digital IC processor. Such a design can reduce the cost of a paper shredder by up to 60%. Typically, the IC processor is used to, among other things, provide an automatic reverse function, in which the shredder motor and blades automatically revers upon the paper inlet throat becoming overloaded, or overfull. This can happen when a user attempts to feed into the shredder more pages than the shredder is rated. The all-analog controller can be used with an AC motor or a DC motor.

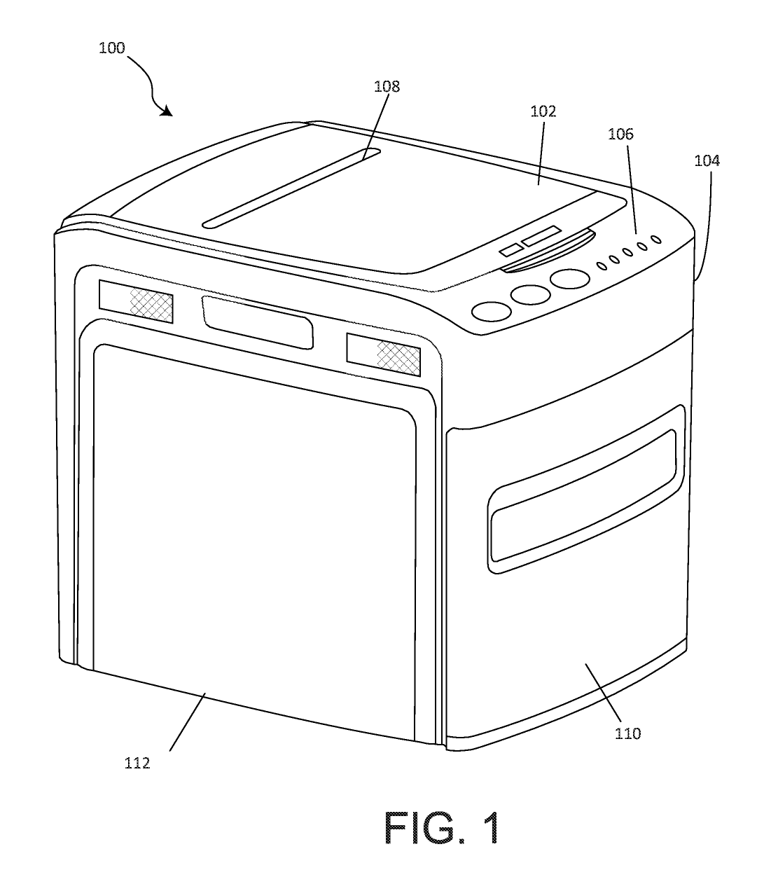

FIG. 1, in general, illustrates paper shredder 100 that could be used without a programmable digital IC processor (all-analog, or “chipless”) in a paper shredder controller (internal, not shown), as described by the embodiments herein. Such chipless controllers would be all analog by comparison. An example of such a shredder can be shredder 100. Shredder 100 can include shredder cover 102, shredder head 106, shredder control and indicator light panel 106, feed slot 108, wastebin with wastebin door 110, and wastebin 112. Feed slot 108 can be disposed above shredder blades, which turn paper input into feed slot 108 into waste “shreddant,” after which shreddant is directed into wastebin 112.

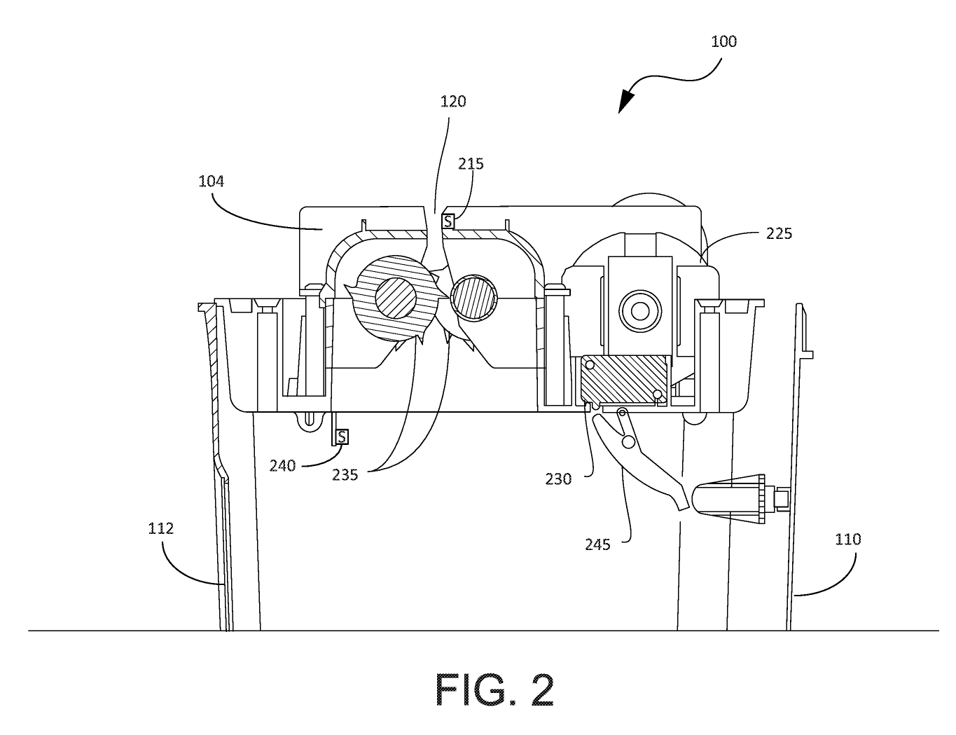

FIG. 2 is a side view illustration of the structures, some of which may be internal to shredder 100. Shredder 100 may include shredder motor 225, which can turn shredder blades 235, when activated. Shredder blades 235 can include at least a pair of counter-rotating blades interposed with close tolerances. When paper is placed in feed slot 120, sensor 215 can detect its presence, causing shredder motor 225 to turn on. The inserted paper is comminuted into shreddant (waste material). Shreddant falls into and can accumulate within wastebin 112 until paper full sensor 240 detects a high level limit of shreddant, causing shredder motor 225 to turn off until the shreddant is removed. When wastebin door 110 is opened to remove accumulated shreddant, wastebin door status sensor 245 detects the operation. Wastebin door status sensor 245 is shown as a pin-and-throw switch-type of door open/closed sensor coupled with a single throw, double pole switch 230, although other types of sensors, including electronic and electromechanical, are contemplated. Once shreddant has been cleared from wastebin 112, and wastebin door 110 is closed, shredder motor 225 enters standby mode awaiting insertion of paper into feed slot 120.

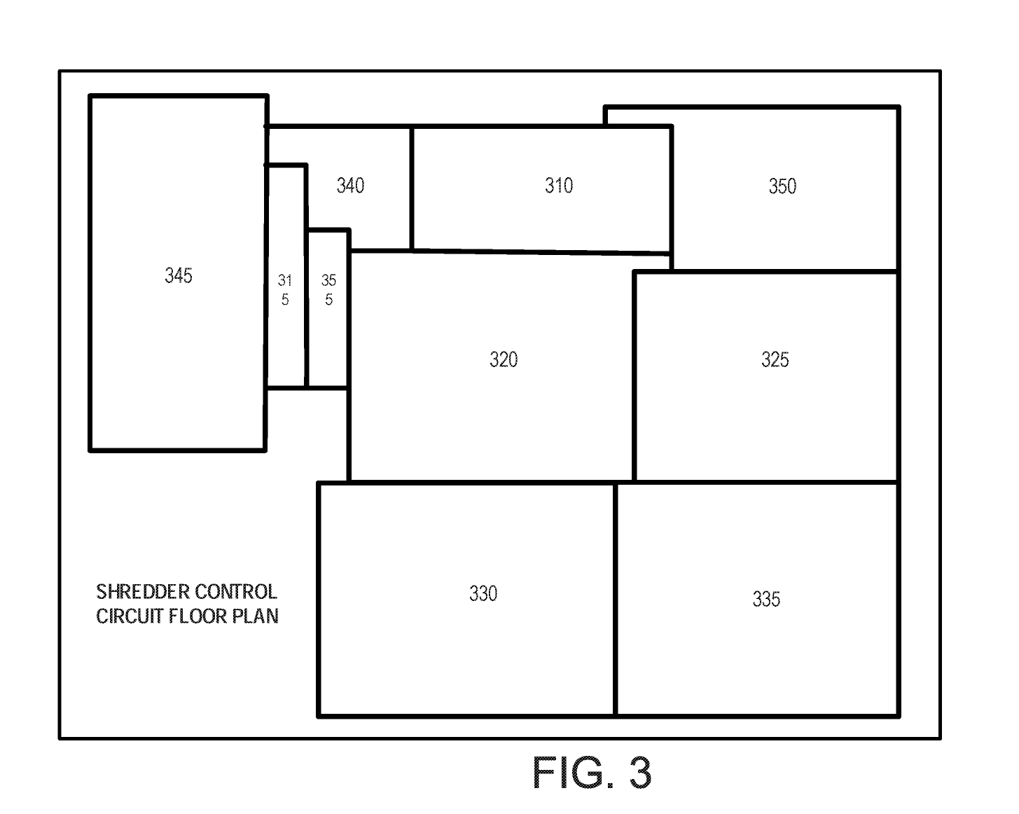

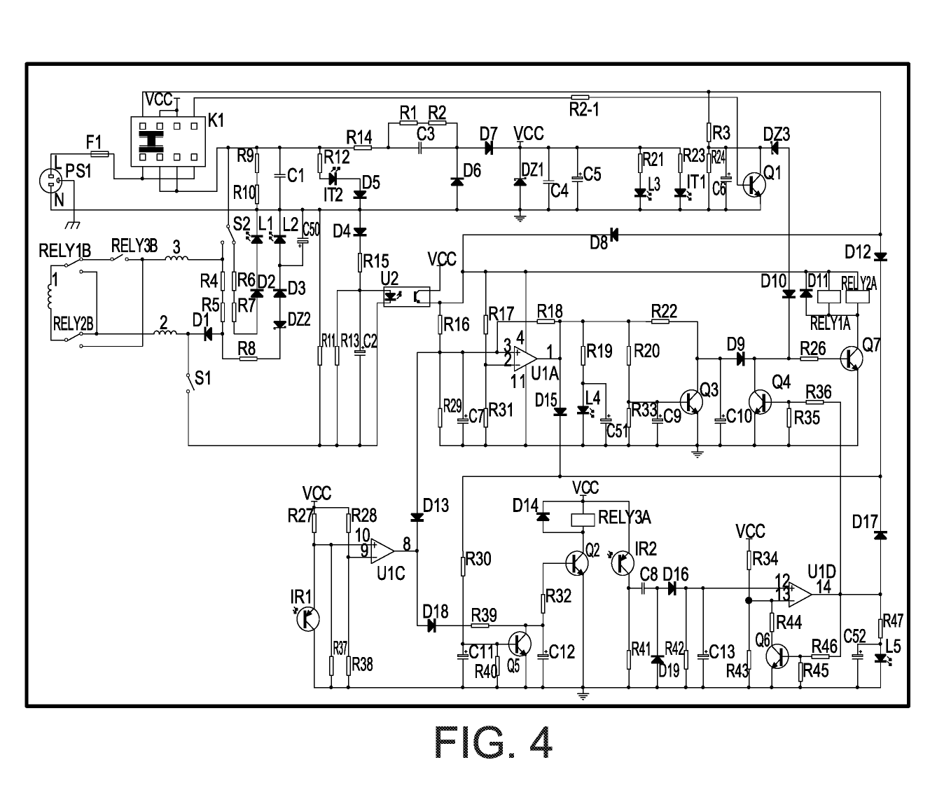

Circuit schematic floorplan layout 300 of FIG. 3 describes the relative position of certain embodiments of operative circuits, which could be used in a chipless paper shredder controller 300. The following also refers to FIG. 4, an embodiment of chipless paper shredder controller schematic which can include power supply circuit 310, door open switch circuit 315, overload circuit 320, automatic forward control circuit 325, automatic reverse control circuit 330, paper full circuit 335, wastebin full circuit 340, frame relay switch circuit including reversing switch (forward-reverse control and relays circuit) 345, forward-reverse model delay setting circuit 350, and overheating protection circuit 355.

Power supply circuit 310 uses the RC Buck principle: power line L passes power through discharge resistors R1, R2, and parallel coupling capacitor C3. Power then is rectified by D6 and D7, followed by Zener diode DZ1. Capacitors C4, C5 and resistor R21 filter power through L3. LED L3 illuminates as the POWER light when the power supply circuit is energized in shredder 100.

Door open switch circuit 315 is coupled to the power supply circuit 310 and can use a single throw, double pole switch, such as switch 230 in FIG. 2. In operation, when S2 conducts from switch S2 pole 1 to switch S2 pole 2, the wastebin door is closed, thereby allowing the shredder motor and shredder circuitry to be in standby. However, when shredder waste bin door opens, the operation circuit continuity is broken. Switch S2 is changed to conduct from switch S2 pole 1 to switch S2 pole 3, transmitting power through current-limiting resistors R6 and R7, and blocking diode D2 to LED L1 and through resistors R10 and R11 to neutral (N). The latter circuit configuration illuminates LED L1 to indicate that the wastebin door is open. Further, the motor turns off, and the shredder circuitry stops functioning.

Overload circuit 320 can include current sampling resistor R11, rectifier diode D4, the current limiting resistor R15, filter capacitor C2, and optocoupler U2. When the current increases through R15, optocoupler U2 is turned on. When optocoupler U2 turns on, VCC is passed through divider subcircuit R16 and R29 and coupled to non-inverting input (pin 3) of the comparator U1A. Non-inverting input (pin 3) of comparator U1A also is coupled to delay capacitor C7. Optocoupler U2 also is source for the comparator U1A inverting input (pin 2), which is coupled to the inverting input by way of dividing resistors R17, R31. When the non-inverting input (pin 3) voltage is higher than inverting input (pin 2), comparator U1A output (pin 1) assumes a high value, which is fedback through resistor R18, locking in the overload signal, and causing lamp L4 to illuminate indicative of an OVERLOAD condition. The motor shuts off.

Automatic reverse control circuit 325 can include resistors R20, R22, R26, R33, R35, R36, capacitors C9 and C10, transistors Q7 and Q3, diodes D9, D10, and D11, and relay elements RELY1A and RELY2A. Automatic reverse circuit activates in an overload condition, in an attempt to clear an excess of paper from the paper feed slot. When the overload circuit 320 resistor R18 output reaches a high level, the HIGH signal traverses R22, D9, and R26, turning on Q7. When Q7 is ON, RELY1 and RELY2 OPEN in response to relay elements RELY1A and RELY2A, respectively, which causes the motor to automatically operate in the reverse direction. In addition, the HIGH signal from R18 also traverses R20, R33, and delay capacitor C9. When C9 is fully charged, Q3 is turned ON, causing Q7 to turn OFF. When Q7 turns OFF, RELY1 and RELY2 are caused to CLOSE, stopping the automatic reverse operation. The time for automatic reverse operation is a predetermined period established, in part, by the value of capacitor C9.

Automatic forward control circuit 330 operates when paper is detected at the feed opening. When paper is at the opening of the feed slot, the illumination of IR1 by IT1 is blocked, which sends the non-inverting pin (pin 10) of op-amp U1C to a value that is higher than the inverting input (pin 9). As a result, the comparator U1C output (pin 8) goes HIGH, which signal propagates through diode D18, and resistors R39 and R32, to the base of transistor Q2. As a result, Q2 turns ON, causing RELY3A to turn ON, beginning the automatic forward operation.

Wastebin full circuit 335 can include infrared transmitter device IT2, infrared receiver device IR2, capacitor C8, full-wave rectifier D16, D19, with a smoothing capacitor C13 feeding the non-inverting input (pin 12) of comparator op-amp U1D. Inverting input (pin 13) is supplied by way of R34, R43, and the feedback network including R44, switch Q6, and resistors R45 and R46. When shreddant accumulates to a predetermined level in the shredder wastebin, infrared transmitter IT2 emission to infrared receiver IR2 is blocked, which causes non-inverting input (pin 12) of comparator op-amp U1D to be charged over a preselected period by C13, causing U1D output (pin 14) to go HIGH. This HIGH signal is propagated back into automatic forward control circuit 330, through R30 to switch Q5. Switch Q5 is turned ON, and this signal is transmitted to Q2, causing switch Q2 to turn ON. When Q2 turns ON, RELY3A is caused to turn OFF, and the motor stops working. The HIGH output from U1D is transmitted to LED lamp L5, which illuminates to indicate the WASTEBIN FULL condition.

Infrared emission control circuit 340 for wastebin full circuit 335 can employ infrared transmitter IT2 and diode D5 to protect IT2 from excessive reverse-phase current. IT2 can be used to detect the level of shreddant in the wastebin which, when at a predetermined level, causes IT2 to illumination to infrared receiver device IR2 in paper full circuit 335 to be blocked. By illuminating IR2, non-inverting input (pin 12) in comparator U1D is driven HIGH, causing the circuit to operate as stated above.

Forward-reverse control and relays circuit 345 operates the shredder relays (RELY1, RELY2, and RELY3) which control the forward and reverse motion of the shredder motor and blades. In embodiments, activating RELY1B and RELY2B cause the motor to operate in the reverse direction, while activating RELY3B causes the motor to operate in the forward direction. Element K1 can be a reversing toggle switch, which can provide control to operate the motor in the forward or reverse direction or to place the motor in STOP.

Forward-reverse model delay setting circuit 350 can include resistor R2-1 connected to the base of switch Q1, resistive divider R3, R24, and timing capacitor C6, which are coupled between switch Q1 collector and emitter. Coupled to switch Q1 collector can be Zener diode DZ3. Also coupled to switch Q1 emitter can be infrared transmitter IT1. The resistance of R2-1 can vary with the temperature of the motor. When the motor reaches the predetermined temperature indicative of overheating, switch Q1 turns ON. IT1 can illuminate IR1 in automatic forward circuit 330, which can ultimately turn Q2 OFF, causing RELY3A to turn OFF, stopping automatic forward operation.

Overheating circuit 355 can include thermostat (overheating switch) S1, diode D1, rectifier diode D3, Zener diode DZ2, current limiting resistors R4, R5, and R8, filter capacitor C50 and LED L2. In normal operation, thermostat switch S1 is CLOSED, allowing current to flow through R4 and R5, diode D1 and switch S1. When an overheating condition is sensed, thermostat switch S1 OPENS, the motor turns OFF, directing current through R4, R5, R8, DZ2, rectifying diode D3, and through overheat indication LED L2.

The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings, although not every figure may repeat each and every feature that has been shown in another figure in order to not obscure certain features or overwhelm the figure with repetitive indicia. It is understood that the invention is not limited to the specific methodology, devices, apparatuses, materials, applications, etc., described herein, as these may vary. It is also to be understood that the terminology used herein is used for the purpose of describing particular embodiments only, and is not intended to limit the scope of the invention.

What is claimed is:

1. A paper shredder controller, comprising:
a power supply circuit, coupled to:
a door open switch circuit;
an automatic forward control circuit;
an automatic reverse control circuit; and
a wastebin full circuit,
wherein the controller is an all-analog controller and lacks a programmable digital integrated circuit.

2. The paper shredder controller of claim 1, further comprising:
an overload circuit coupled to the power supply circuit.

3. The paper shredder controller of claim 1, further comprising:
a forward-reverse control and relays circuit, coupled to the power supply circuit.

4. The paper shredder controller of claim 1, further comprising:
a forward-reverse model delay setting circuit, coupled to the power supply circuit.

5. The paper shredder controller of claim 1, further comprising:
an overheating protection circuit, coupled to the power supply circuit.

6. The paper shredder controller of claim 1, further comprising:
a POWER indicator light, coupled to the power supply circuit, and indicative of the power supply circuit being energized;
a DOOR OPEN light coupled to the door open switch circuit, and indicative of a wastebin door being open;
an AUTOMATIC FORWARD light, coupled to the automatic forward control circuit, and indicative of the shredder operating in a automatic forward mode;
a WASTEBIN FULL light, coupled to the wastebin full circuit, and indicative of a wastebin being full.

7. The paper shredder controller of claim 5, further comprising:
an OVERHEATING light, coupled to the overheating circuit, and indicative of overheating.

8. A paper shredder with a housing; comprising:
a motor within the housing;
counter-rotating shredder blades coupled to the motor and covered by the housing;
a wastebin coupled to the housing and disposed beneath the shredder blades; and
an all-analog shredder controller board coupled to the housing, and configured to operate the paper shredder in an automatic forward direction and an automatic reverse direction.

9. A paper shredder, comprising:
an all-analog controller that lacks a programmable digital integrated circuit coupled to a power supply circuit, the power supply circuit coupled to and the all-analog controller controlling:
a door open switch circuit;
an automatic forward control circuit;
an automatic reverse control circuit;
a wastebin full circuit;
an overload circuit;
a forward-reverse control and relays circuit;
a forward-reverse model delay setting circuit; and
a motor overheating protection circuit.

10. The paper shredder of claim 9, further comprising:
a POWER indicator light, coupled to the power supply circuit, and indicative of the power supply circuit being energized;
a DOOR OPEN light coupled to the door open switch circuit, and indicative of a wastebin door being open;
an AUTOMATIC FORWARD light, coupled to the automatic forward control circuit, and indicative of the shredder operating in an automatic forward mode;
a WASTEBIN FULL light, coupled to the wastebin full circuit, and indicative of a wastebin being full; and
a MOTOR OVERHEATING light, coupled to the motor overheating circuit, and indicative of a motor overheating condition.

11. The paper shredder of claim 9, further comprising:
an alternating current motor coupled to the all-analog controller.

12. The paper shredder of claim 9, further comprising:
an direct current motor coupled to the all-analog controller.
